(19) United States
(12) Patent Application Publication
(10) Pub. No.: US 2022/0204366 A1
(43) Pub. Date: Jun. 30, 2022

(54) CAPACITIVE DEIONIZATION WITH ZERO WASTEWATER

(71) Applicant: UWM Research Foundation, Inc., Milwaukee, WI (US)

(72) Inventors: Junhong Chen, Chicago, IL (US); Xingkang Huang, Darien, IL (US)

(21) Appl. No.: 17/605,133

(22) PCT Filed: Apr. 22, 2020
(86) PCT No.: PCT/US2020/029290

§ 371 Date: Oct. 20, 2021

Related U.S. Application Data
(60) Provisional application No. 62/837,070, filed on Apr. 22, 2019.

(51) Int. Cl. C02F 1/469; C02F 1/461; C02F 1/00

(52) U.S. Cl. CPC C02F 1/4691; C02F 1/46109; C02F 2101/20; C02F 2001/46138; C02F 1/001

(57) ABSTRACT

A water purification system comprising a thiol-functionalized graphene oxide/activated carbon composite material, a filter and one or more capacitive deionization cells with applications in removal of water contaminants such as heavy metal ions without generation of wastewater.

### CROSS-REFERENCE TO RELATED APPLICATIONS

This application claims priority to U.S. Provisional Application No. 62/837,070, filed Apr. 22, 2019, which is hereby incorporated by reference in its entirety.

### STATEMENT OF GOVERNMENT INTEREST

This invention was made with government support under grant number 1540032 awarded by the National Science Foundation. The government has certain rights in the invention.

### TECHNICAL FIELD

The present disclosure relates to zero-wastewater capacitive deionization technology using a thiol-functionalized graphene oxide/activated carbon composite material with applications in removal of water contaminants such as heavy metal ions without generation of wastewater.

### BACKGROUND

Heavy metal ions in drinking water are harmful to human health and should be reduced to below their action levels, e.g., 15 parts per billion (ppb) for lead (Pb), as recommended by the U.S. Environmental Protection Agency (US EPA). According to the World Health Organization (WHO), Mg²⁺ and Ca²⁺ must be partially removed in drinking water to reduce hardness when their concentrations are higher than 30 and 80 parts per million (ppm), respectively. However, the minimum content for Mg²⁺ and Ca²⁺ in drinking water is 10 and 30 ppm, respectively, and because of their benefits to human health, as recommended by WHO, these ions do not need to be removed completely. In contrast, heavy metals such as Pb²⁺ are poisonous, even at low concentrations. Pb interferes with neurodevelopment, particularly by reducing intelligence quotient (IQ), and thus requires additional attention. Because many aging water pipes in the US contain lead, the lead content in tap water is occasionally found to be higher than 15 ppb, especially in the early morning. For example, the lead content from first-draw samples at taps from 50 homes in Milwaukee (Wisconsin, US) in 2017 was up 130 ppb. Due to the high cost for cities to replace aging water pipes, the selective removal of heavy metals from tap water is more effective and economical.

The selective removal of lead has been investigated extensively using methods such as polyethylene glycol methacrylate gel beads, ethylenediamine-modified attapulgite, sol-gel-derived ion-imprinted silica-supported organic-inorganic hybrid sorbent, ion-imprinted silica sorbent functionalized with chelating N□donor atoms, bulk liquid membranes containing crown ether and oleic acid as carrier, magnetic 2-hydroxyethylammonium sulfonate immobilized on γ-Fe₂O₃ nanoparticles, natural clayey, hydrous manganese dioxide, α-MoO₃ porous nanosheets array, and hollow mesoporous silica loaded with molecularly imprinted polymer.

Compared with other water-purifying techniques (e.g., reverse osmosis, RO), the advantages of CDI include a low lifecycle cost, the ability to remove a wide range of ionic contaminants, a high recovery rate, and low energy consumption. Selective removal of lead ions in synthetic water (ultrapure water with target ion salts) using activated carbon with CDI in the presence of anion-exchange membranes (AEM-CDI) has been shown.

Activated carbon (AC) electrodes exhibit selective removal of Pb²⁺ against Ca²⁺ and Mg²⁺, but the selectivity is low.

Thus, there remains a need for a zero-wastewater CDI technology that can continuously charge and discharge without generating wastewater by utilizing native large anionic groups (e.g. phosphate ions) in tap water to remove heavy metals (e.g. Pb²⁺) by forming precipitates that can be removed by filters, and leave most of the harmless and beneficial components in tap water (e.g. Ca²⁺ and Mg²⁺) unchanged.

### SUMMARY

The present disclosure relates to the selective removal of lead ions in tap water with a single-pass mode. The present disclosure demonstrates that phosphate ions in tap water significantly affect the ability to remove lead ions. The presence of phosphate ions results in Pb particulate rather than free ions. Upon charging, Pb ions accumulate on cathodes (e.g. electrosorbing) and are then released at high concentrations during discharge. When the accumulated large anionic groups (e.g. phosphate ions) are discharged from anodes, they can react with the discharged heavy metal ions (e.g. Pb ions) from the counter electrodes and form precipitates. Conventional CDI removes ions upon charging while releasing accumulated ions upon discharging, generating concentrated wastewater. Besides wasting water, further processes may be required to treat the wastewater from conventional CDI devices, which increases the cost and the energy footprint. Unlike conventional CDI, the present invention allows for the resulting phosphate precipitates to be easily collected with filters equipped in a pipeline without discharging wastewater (i.e. zero-wastewater CDI).

Disclosed herein are composite materials and devices for removal of heavy metals from a water supply (e.g., Pb, Cu, Cd, Ni, Hg) without generating wastewater.

In one aspect, the invention provides a composite material comprising activated carbon and thiol-functionalized graphene oxide coated on the activated carbon.

In another aspect, the invention provides an electrode comprising the composite material described herein.

In another aspect, the invention provides a capacitive deionization cell comprising the herein-described electrode comprising the composite material.

In another aspect, the invention provides a water purification system comprising one or more capacitive deionization cells, as described herein, an electrical circuit for controlling the operation of the one or more capacitive deionization cells, and a filter, the filter being in fluid communication with the one or more capacitive deionization cells.

In another aspect, the invention provides a method of removing a heavy metal ion from a water supply comprising (a) applying a voltage to one or more capacitive deionization cells, as described herein; (b) directing the water supply through the one or more capacitive deionization cells; and (c) adsorbing the heavy metal ion at the first electrode; wherein the heavy metal ion is a lead, copper, cadmium, nickel, or mercury ion.

### BRIEF DESCRIPTION OF THE DRAWINGS

This patent or application file contains at least one drawing executed in color. Copies of this patent or patent application publication with colors drawings will be provided by the Office upon request and payment of the necessary fee.

FIG. 1. SEM images of (A-C) AC and (D-F) MPG-GO/AC. (F) was magnified from the yellow rectangle zone in (E), showing the surface of AC was coated by MPG-GO.

FIG. 2. SEM images of MPG-GO/AC: (B), (C), and (D) were locally zoomed-out images, marked by yellow, orange, and green rectangles in (A).

FIG. 3. (A) XRD patterns and (B) Raman spectra of AC, GO, and MPS-GO/AC.

FIG. 4. (A) EDS, (B) FTIR spectra of AC, GO, and MPS-GO/AC, and (C) XPS spectra of MPG-GO/AC.

FIG. 5. CDI performance with various electrodes: (A) Four-layer electrode cell with AC (B), Eight-layer electrode cell with AC (C), Four-layer electrode cell with functionalized graphene/AC composite, and (D) Four-layer electrode cell with functionalized graphene/AC composite at a high flow rate of 92 mL min⁻¹. The synthetic water was used by adding 1 ppm Pb²⁺, 1 ppm Ca²⁺, and 1 ppm Mg²⁺ in ultra-pure water. Only AEM was applied without cation exchange membrane (CEM).

FIG. 6. Removal selectivity of Pb against Ca (A) and Mg (B) using AC and MPS-GO/AC electrodes. Note that the CDI cells were subjected to 5-min wetting before starting charging. The timeline in the figures was consistent with that of FIG. 5.

FIG. 7. CDI performance of the MPS-GO/AC in tap water at a flow rate of 23 mL min⁻¹. (A) Removal rates during charge/discharge, in which C and D represent charge and discharge process, respectively, and (B) Pb removal selectivity against Ca²⁺ and Mg²⁺. The sample solutions were taken at the 1st, 7th, 19th, and 24th hours with a typical charge time of 10 min and discharge time of 2 min. A 3 min discharge time was applied at the 19th cycles. The solution was filtrated using filters to remove precipitates unless stated otherwise.

FIG. 8. Regeneration performance of a four-layer-electrode cell with synthetic water, with 1 ppm Pb, 30 ppm Ca, and 10 ppm Mg at a flow rate of 23 mL min⁻¹: (A) Charge (10 min each cycle) and (B) discharge (2 min, or else if stated). Note that three groups of the charge/discharge samples were taken at the first three cycles every 3 h, then the cell was kept running without sampling for 2.5 h.

FIG. 9. (A) Optical photo of an electrode after use, (B) SEM images, (C) EDS analysis, and (D) XRD pattern of the white precipitates collected from the electrode.

FIG. 10. Mean particle size of particulates in tap water after addition of 1 ppm Pb²⁺.

FIG. 11. Illustration of typical CDI performance of (A) synthetic water without phosphate ions, and (B) tap water with phosphate additives.

### DETAILED DESCRIPTION

### 1. Definitions

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing of the present invention. All publications, patent applications, patents and other references mentioned herein are incorporated by reference in their entirety. The materials, methods, and examples disclosed herein are illustrative only and not intended to be limiting.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “an” and “the” include plural references unless the context clearly dictates otherwise. The present disclosure also contemplates other embodiments “comprising,” “consisting of” and “consisting essentially of,” the embodiments or elements presented herein, whether explicitly set forth or not.

The modifier “about” used in connection with a quantity is inclusive of the stated value and has the meaning dictated by the context (for example, it includes at least the degree of error associated with the measurement of the particular quantity). The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1. Other meanings of “about” may be apparent from the context, such as rounding off, so, for example “about 1” may also mean from 0.5 to 1.4.

For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

### 2. Composite Materials, Device, and Use

Surface modification helps to improve the selectivity, but the large activated carbon (AC) particles make it unsuitable. Cross-linking agents (i.e. surface modifiers) could be adsorbed into the deep micropores in the large AC particles. In contrast, graphene oxide (GO), consisting of a few C layers in thickness, is much more easily subjected to surface modification. More importantly, the thin GO sheets offer easier Pb release upon discharging compared with AC discharging Pb from the deep micropores. One of the major problems for GO is the agglomeration during drying, which makes it difficult to coat the electrodes with a doctor blade. It is also difficult to grind the aggregated GO sheets smaller than 50 μm, at which uniform coats can be achieved using the doctor blade. As a result, forming a GO/AC composite is an optimum choice for fabricating an electrode for selective removal of lead ions. Due to the high cost of graphene, a GO/AC composite can significantly reduce costs because AC is much cheaper than GO.

The composite material of the present invention may generally be made of an AC and may have a thiol-functionalized GO coating (i.e. MPS-GO/AC). The composite material may have micropores, nanopores, or combinations thereof. The composite material may be coated on a graphite foil to make an electrode and it may be incorporated into a capacitive deionization cell device for use in removing heavy metals from a water supply.

The AC may be in the form of particles. The AC particles may be micro-sized particles. The AC micro-sized particles may be from 0.5-50 μm in diameter, 0.5-49 μm in diameter, 0.5-48 μm in diameter, 0.5-47 μm in diameter, 0.5-46 μm in diameter, 0.5-45 μm in diameter, 0.5-44 μm in diameter, 0.5-43 μm in diameter, 0.5-42 μm in diameter, 0.5-41 μm in diameter, 0.5-40 μm in diameter, 0.5-39 μm in diameter, 0.5-38 μm in diameter, 0.5-37 μm in diameter, 0.5-36 μm in diameter, 0.5-35 μm in diameter, 0.5-34 μm in diameter, 0.5-33 μm in diameter, 0.5-32 μm in diameter, 0.5-31 μm in diameter, 0.5-30 μm in diameter, 0.5-29 μm in diameter, 0.5-28 μm in diameter, 0.5-27 μm in diameter, 0.5-26 μm in diameter, 0.5-25 μm in diameter, 0.5-24 μm in diameter, 0.5-23 μm in diameter, 0.5-22 μm in diameter, 0.5-21 μm in diameter, 0.5-20 μm in diameter, 0.5-19 μm in diameter, 0.5-18 μm in diameter, 0.5-17 μm in diameter, 0.5-16 μm in diameter, 0.5-15 μm in diameter, 0.5-14 μm in diameter, 0.5-13 μm in diameter, 0.5-12 μm in diameter, 0.5-11 μm in diameter, 0.5-10 μm in diameter, 0.5-9 μm in diameter, 0.5-8 μm in diameter, 0.5-7 μm in diameter, 0.5-6 μm in diameter, 0.5-5 μm in diameter, 0.5-4 μm in diameter, 0.5-3 μm in diameter, 0.5-2 μm in diameter, or 0.5-1 μm in diameter. In a particular embodiment, the AC micro-sized particles may be from 1-6 μm in diameter.

The AC has a network of pores that may be macropores, mesopores, micropores, or combinations thereof. Macropores are greater than 50 nm in diameter, mesopores are 2-50 nm in diameter, and micropores are less than 2 nm in diameter. Micropores generally contribute to the major part of the AC particle's internal surface area. Macro and mesopores can generally be regarded as the highways into the AC particle and contribute to kinetics. The pores may be adsorption pores, transport pores, or combinations thereof. Adsorption pores have sufficient adsorption forces to adsorb impurities and are the smallest pores within an AC particle. Transport pores are the largest pores within the particle and consist of a wide variety of different sizes and shapes of structures over five orders of magnitude within an AC particle. Transport pores are too large to adsorb and therefore act as diffusion paths to transport the adsorbate to the adsorption sites.

The pores are generally circular or oval-shaped. For circular or substantially circular pores, the pore size refers to the diameter of the pore. For pores that are substantially unsymmetrical or irregularly shaped (as may occur particularly for pores delineated by surfaces of conductive carbon nanoparticles), the pore size generally refers to either the average of the pore dimensions for a particular pore, or to the average or longest dimension of such pores averaged over a population of such pores.

In some embodiments, the AC comprises mesopores and/or micropores. In some embodiments, the AC comprises mesopores and/or micropores, but not macropores. The AC may comprise pores less than 1 nm, less than 2 nm, less than 3 nm, less than 4 nm, less than 5 nm, less than 6 nm, less than 7 nm, less than 8 nm, less than 9 nm, less than 10 nm, less than 11 nm, less than 12 nm, less than 13 nm, less than 14 nm, less than 15 nm, less than 16 nm, less than 17 nm, less than 18 nm, less than 19 nm, less than 20 nm, less than 21 nm, less than 22 nm, less than 23 nm, less than 24 nm, less than 25 nm, less than 26 nm, less than 27 nm, less than 28 nm, less than 29 nm, less than 30 nm, less than 31 nm, less than 32 nm, less than 33 nm, less than 34 nm, less than 35 nm, less than 36 nm, less than 37 nm, less than 38 nm, less than 39 nm, less than 40 nm, less than 41 nm, less than 42 nm, less than 43 nm, less than 44 nm, less than 45 nm, less than 46 nm, less than 47 nm, less than 48 nm, less than 49 nm, or less than 50 nm. Further, the AC pores may be from about 1-2 nm, 1-3 nm, 1-4 nm, 1-5 nm, 1-6 nm, 1-7 nm, 1-8 nm, 1-9 nm, 1-10 nm, 1-11 nm, 1-12 nm, 1-13 nm, 1-14 nm, 1-15 nm, 1-16 nm, 1-17 nm, 1-18 nm, 1-19 nm, 1-20 nm, 1-21 nm, 1-22 nm, 1-23 nm, 1-24 nm, 1-25 nm, 1-26 nm, 1-27 nm, 1-28 nm, 1-29 nm, 1-30 nm, 1-31 nm, 1-32 nm, 1-33 nm, 1-34 nm, 1-35 nm, 1-36 nm, 1-37 nm, 1-38 nm, 1-39 nm, 1-40 nm, 1-41 nm, 1-42 nm, 1-43 nm, 1-44 nm, 1-45 nm, 1-46 nm, 1-47 nm, 1-48 nm, 1-49 nm, 1-50 nm, 2-50 nm, 3-50 nm, 4-50 nm, 5-50 nm, 6-50 nm, 7-50 nm, 8-50 nm, 9-50 nm, 10-50 nm, 11-50 nm, 12-50 nm, 13-50 nm, 14-50 nm, 15-50 nm, 16-50 nm, 17-50 nm, 18-50 nm, 19-50 nm, 20-50 nm, 21-50 nm, 22-50 nm, 23-50 nm, 24-50 nm, 25-50 nm, 26-50 nm, 27-50 nm, 28-50 nm, 29-50 nm, 30-50 nm, 31-50 nm, 32-50 nm, 33-50 nm, 34-50 nm, 35-50 nm, 36-50 nm, 37-50 nm, 38-50 nm, 39-50 nm, 40-50 nm, 41-50 nm, 42-50 nm, 43-50 nm, 44-50 nm, 45-50 nm, 46-50 nm, 47-50 nm, 48-50 nm, or 49-50 nm.

Targeted removal of heavy metal ions using GO/AC composites may be improved if the active materials on the cathodes are chosen with or modified by functional groups that have a strong affinity for heavy metal ions. These functional groups can help to accumulate heavy metal ions during charging, thereby increasing the removal efficiency of heavy metal ions in the water.

In some embodiments the graphene may be graphene oxide, graphite sheets, reduced graphene oxide, or functionalized versions of any form of graphene. In some embodiments the graphene may be a sheet or any other shape known to one of skill in the art.

The GO/AC composite may be modified with thiol groups. The thiol groups have a strong affinity to heavy ions (such as Pb²⁺), leading to the very high Pb removal selectivity against Ca²⁺ and Mg²⁺. The GO may be functionalized with a thiol-containing group, the thiol-containing group may comprise a —C₁₋₁₀alkylene-SH group. The “C₁₋₁₀alkylene” refers to a divalent group derived from a straight or branched chain saturated hydrocarbon. Representative examples of alkylene include, but are not limited to, —CH₂—, —CH₂CH₂—, —C(CH₃)(H)—, —CH₂CH₂CH₂—, —CH₂CH₂CH₂CH₂—, and —CH₂CH₂CH₂CH₂CH₂—. The thiol-containing group may be -silyl-C₁₋₁₀alkylene-SH. The -silyl-C₁₋₁₀alkylene-SH group may be -silyl-(CH₂)₃—SH.

Hydroxyl groups attached to the basal planes of GO sheets can be effective attachment sites for different chemical agents. For example, the surface can be modified by silanization, a process that coats a surface with organofunctional alkoxysilane molecules. The silyl group in -silyl-C₁₋₁₀alkylene-SH attaches to the GO through an oxygen atom on the GO surface. The -silyl-C₁₋₁₀alkylene-SH group may be bonded to the GO by reaction of a surface hydroxyl with a trialkoxysilyl reagent, such as a trimethoxy- or triethoxy-silyl reagent. Thus, the silyl may be, for example, a —Si(OC₁₋₄alkyl)₂— such as a —Si(OCH₃)₂— or —Si(OCH₂CH₃)₂— group. Alternatively, two silyl groups in sufficiently close proximity on the GO surface may cross-condense to form a —Si(OC₁₋₄alkyl)(R)—O—Si(OC₁₋₄alkyl)(R)— group, or similar group, wherein each R is a —C₁₋₁₀alkylene-SH.

In some embodiments the MPS-GO/AC composite material may display broad X-ray diffraction (XRD) peaks at about 12.6° and about 42°, which are typical peaks for poorly crystallized AC.

In some embodiments the Raman spectra of the MPS-GO/AC composite may exhibit an intensity ratio of D and G bands (I_{D}/I_{G}) ratio of about 1.3, which mainly results from the high content of defects in the AC. The I_{D}/I_{G} ratio could be a wide range (e.g. from about 0.3 to about 3) dependent on the property of the GO, the AC, and their ratio.

In some embodiments energy dispersive X-ray spectroscopy (EDS) analysis of the MPS-GO/AC composite may present a C content of about 82.5 and an O content of about 15.8 wt. %. In some embodiments EDS analysis of the MPS-GO/AC composite may reveal a Si content of about 0.82 and a S content of about 0.89 wt. %. In some embodiments the MPS-GO/AC composite material may comprise 0.1 to 5 wt. %, 0.1 to 4 wt. %, 0.1 to 3 wt. %, 0.1 to 2 wt. %, 0.1 to 1 wt. %, 0.5 to 4.5 wt. %, 0.5 to 3.5 wt. %, 0.5 to 2.5 wt. %, 0.5 to 1.5 wt. % sulfur.

In some embodiments the MPS-GO/AC composite material may exhibit Fourier-transform infrared spectra (FTIR) C═O peaks at about 1,738 cm¹.

The composite material may further include carbon black.

The composite material may comprise a binder. The binder may be a polyvinylidenefluoride (PVDF)-based binder. The binder may be polyvinylidenefluoride (PVDF) homopolymers, polyvinylidene fluoride-hexafluoropropylene (PVDF-HFP), polyvinylidene fluoride-trichloro Polyvinylidene fluoride-trichloroethylene (PVDF-TCE), polyvinylidene fluoride-trifluoroethylene (PVDF-CTFE), polymethylmethacrylate (PMMA), polybutylacryl Polybutylacrylatem PBA, polyacrylonitrilem PAN, polyvinylpyrrolidone (PVP), polyvinylacetate (PVAc), polyvinyl alcohol (polyvinyl alcohol, PVAI), polyethylene vinyl acetate copolymer (polyethylene-co-vinylacetate, PEVA), polyethylene oxide PEO, poly Arylate (polyarylate, PAR), cellulose acetate (CA), cellulose acetate butyrate (CAB), cellulose acetate propionate (CAP), cyanoethylpullulan (CYEPL), Cyanoethyl polyvinylalcohol (CRV), cyanoethyl cellulose (CEC), cyanoethyl sucrose (CRU), pullulan, carboxyl methyl cellulose, CMC), polyimide (Polyimide, PI), polyamic acid (Polyamic Acid, PAA), polytetrafluoroethylene (PTFE), or combinations thereof. If two or more binders, the weight average molecular weight (Mw) of each binder may be the same or different as necessary.

The composite material described herein may be incorporated into an electrode. The electrode may further include a current collector, with the composite material being coated on the current collector. Suitable materials for the current collector include a conductive carbon material or titanium. In turn, the conductive carbon may be a graphite body, carbon paper, or carbon cloth. The electrode may be scalable. The electrode may be 1 in to 20 ft.

The electrode may be incorporated into a CDI cell for removal of contaminants from a water supply. Generally, the CDI cell contains a first electrode and a second electrode, the first electrode being the electrode incorporating the composite material described herein. The CDI may further include an anion exchange membrane (AEM). The AEM is a semi-permeable membrane that transports specific dissolved ions and blocks other ions or neutral molecules. The AEM may be of the homogeneous or heterogeneous porous type for electrodialysis or reverse electrodialysis. The AEM may be a standard homogenous for electrodialysis or reverse electrodialysis. The AEM is a semipermeable membrane that may be made from ionomers and is designed to conduct anions while being impermeable to gases such as oxygen or hydrogen. The AEM may prevent migration of metal ions bound to a ligand from the anode electrolyte to the cathode electrolyte. The AEM may comprise a reinforced material such as polyester. The AEM may be made with or without reinforcement. The AEM may have a thickness between 20-130 μm or 20-75 μm or 50-100 μm. The AEM may have an ion exchange capacity from about 0.75-0.85 mmol g⁻¹. The AEM may have a selectivity from about 92-99/6, 92-97%, about 93-97%, about 94-97%, or about 95-97%. The AEM may have a specific area resistance of about 2-3 Ωcm². The AEM may be stable at a pH from about 1-9, about 2-8, about 3-7, about 4-7, or about 5-7. It is apparent to a person skilled in the art that the AEM may be optimized in view of thickness, conductivity, permselectivity, and/or area resistance, depending on the application. The AEM can be tailored to be selective to only let specific species of anions or cations pass, such as for example monovalent ions and thus can serve to desalinate water, separate different species or kinds of ions and/or serve to selectively and/or essentially non-selectively remove or concentrate ions. For example, the AEM may be use for desalination processes, concentration of salts, acids and bases, nitrogen removal from drinking water, etc. The AEM may have low resistance, high selectivity, very high mechanical stability, and high stability in pH neutral and acidic environments. The AEM may separate an anode chamber and a cathode chamber. In some embodiments, the AEM may be used in conjunction with a size exclusion membrane so that migration of metal ions bound to a ligand from the anode electrolyte to the cathode electrolyte is prevented. It is apparent to the person skilled in the art that the mechanism allows for the separation of smaller from larger organic acids, bases and amphoteric molecules depending on the properties of the AEM and the redox-active non-conductive particles. To the person skilled in the art it is also apparent that such flow and cell configuration maybe of large scale for industrial separations as well as small microfluidic and analytical flow cell configurations.

The CDI cell may be a lamellar cell or cylindrical cell. the CDI cell may be configured as a flow-by mode cell or a flow-through cell. The CDI device that may consist of lamellar or cylindrical jellyroll cathodes and an anode with plastic mesh separators.

A CDI device generally includes at least the feature of two porous electrodes of opposite polarity spaced in such a manner that flowing liquid (typically water, or an aqueous solution containing water) makes contact with the electrodes. In some embodiments, the electrodes are separated by an insulating material that permits the flow therethrough of water to be deionized by inclusion of flow channels in the insulating material. The insulating material includes means (e.g., spaces, channels, or pores) that permit the liquid to make efficient contact with the porous electrodes. When operated (i.e., by applying a suitable voltage bias across the electrodes), the CDI device removes salt species from the water by absorbing cationic species into the negatively charged electrode and anionic species into the positively charged electrode, similar to a capacitor, such as a supercapacitor or electric double-layer capacitor (EDLC), both of which are additional applications for the composite material described herein.

The CDI device can have any of the features and designs known in the art. Reference is made, for example, to U.S. Pat. Nos. 5,636,437, 5,776,633, 5,932,185, 5,954,937, 6,214,204, 6,309,532, 6,778,378, 7,766,981, 7,835,137, U.S. Application Pub. No. 2008/0274407, U.S. Application Pub. No. 2009/0141422, U.S. Application Pub. No. 2009/0305138, U.S. Application Pub. No. 2009/0320253, Jung, et al., Desalination 2007, 216, 377-385, Pekala, et al., Journal of Non-Crystalline Solids 1998, 225, 74-80, and Carriazo, et al., J. Mater. Chem. 2010, 20, 773-780, all of which describe numerous features and designs in CDI, EDLC, and related devices, as well as numerous methods for fabricating electrodes in such devices, as well as methods of operating CDI, EDLC and related devices. The variations and designs of CDI devices, as well as methods of manufacture, and methods of their use, described in the foregoing references, are herein incorporated by reference in their entirety. In some embodiments, one or more features described in said references are excluded from the instant CDT device. Furthermore, in some embodiments, two electrodes are employed, while in other embodiments, more than two, or a multiplicity of electrodes (for example, miniaturized electrodes) are employed. In some embodiments, the electrodes are in a stacked arrangement, such as an alternating left-right arrangement to maximize flow rate. In some embodiments, the CDI device is a membrane capacitive deionization (MCDI) device by employing an anion-exchange membrane coated on the anode and/or a cation-exchange membrane coated on the cathode, wherein the anion- or cation-exchange membrane is generally positioned between the flowing water and respective electrode. In other embodiments, such exchange membranes are excluded from the device.

An aspect of the invention provides a water purification system comprising one or more CDI cells (or a CDT device), as described herein, an electrical circuit for controlling the operation of the one or more capacitive deionization cells; and a filter, the filter being in fluid communication with the one or more capacitive deionization cells. The filter can remove heavy metals from a water source. The filter can selectively remove heavy metals from a water source when in the presence of calcium and/or magnesium. The filter can remove greater than 90%, greater than 91%, greater than 92%, greater than 93%, greater than 94%, greater than 95%, greater than 96%, greater than 97%, greater than 98%, or greater than 99%, of heavy metals from a water source. Generally, the filter may remove precipitates (large particles) from the CDI device. The particulate filter is configured to entrap a phosphate salt of one or more of lead, copper, cadmium, nickel, and mercury. Most filters that can be attached to a pipeline can be used, such as activated alumina filters, activated carbon filters, membrane filters. The phosphate salt may be a lead phosphate salt. The lead phosphate salt may comprise Pb₅(PO₄)₃(OH). Other possible minor components of a filtered lead phosphate salt include minor amounts of Ca, Al, Fe, Cu, and/or Zn.

The system may be used to remove a contaminant from a water supply by contacting the water supply with the CDI device. At least one of the one or more contaminants is a heavy metal. The heavy metal may be Pb, Cu, Cd, Ni, and/or Hg. In one embodiment, the disclosed apparatus and process effectively removes heavy metals from fluids containing particularly high concentrations of contaminants. The heavy metals may be present in the fluid at concentrations of from 10 parts per billion to 5,000 parts per million. The CDI device may use phosphate ions that natively exist in a water supply to remove a contaminant from the water supply. The phosphate ion may be present in the fluid at concentrations of from 1 part per billion to 1,000 parts per million. The disclosed apparatus and process are effective in decreasing the contaminants to levels safe for human exposure to the fluid (such as, for human consumption of the fluid). For example, when the fluid contains Pb the disclosed apparatus and process effectively decreases the Pb level to amounts less than about 15 ppb, in some cases less than about 10 ppb, in others less than about 5 ppb, in still others less than about 2 ppb, and in still others substantially all Pb. In addition, Pb removal rates may be more than about 70%, more than about 75%, more than about 80%, more than about 85%, more than about 90%, more than about 95%, or about 100%.

It can be appreciated, the level to which the one or more contaminants are decreased in the fluid can depend on one or more of: i) the initial contaminant level in the fluid, ii) the contaminant (as for example, without limitation, the chemical and/or physical properties of the contaminant); iii) the conditions under which the contaminant and apparatus are contacted (as for example, without limitation, one or more of contacting temperature and/or length of contacting time); iv) the apparatus physical properties (such as, without limitation, the apparatus size, permeability, and/or pore structure); and v) combinations thereof.

The porosity and permeability can affect the contacting pressure needed to achieve flow fluid through the filter device. The contaminant-containing fluid can flow through the filter device under the influence of gravity, pressure or other means and with or without agitation or mixing. While not wanting to be limited by any theory, the contacting pressure for the contaminant-containing fluid to flow through the filter device decreases the greater one or both of porosity and permeability of the filter material.

The contact time can vary depending on one or more of the geometry and size of the filter material, the porosity and/or permeability of the filter material, the contacting pressure, the fluid properties (such as viscosity, surface tension) and the contaminant and contaminant concentration within the contaminant-containing fluid. The disclosed filter device can effectively remove one or more contaminants from the contaminant-containing fluid.

In operation, heavy metal ions may be removed from a water supply with the CDI cells described herein by (a) applying a voltage to one or more capacitive deionization cells, as described herein; (b) directing the water supply through the one or more capacitive deionization cells; and (c) adsorbing the heavy metal ion at the first electrode; wherein the heavy metal ion is a lead, copper, cadmium, nickel, or mercury ion. This sequence may be referred to as a charging process. Optionally, the methods disclosed herein may include a discharging process involving (d) reversing the voltage; (e) releasing the heavy metal ion from the first electrode into the water supply; (f) directing the heavy metal ion-containing water out of the one or more capacitive deionization cells; and (g) collecting a phosphate salt of the heavy metal ion by filtration. Discharging in this fashion allows the system disclosed herein to be set up for another round of charging to continue removing a heavy metal from the water supply.

A key advantage of the system and method disclosed herein compared to existing CDI technology is the efficient removal of heavy metal ions through the charge-discharge cycles without the need for discharge parts, such as pipes and valves.

The CDI device may be powered by energy sources known to one of skill in the art such as, but not limited to, solar energy, electricity, DC, or portable batteries.

### 3. EXAMPLES

### Example 1

### Materials and Methods

Materials. Lead(II) nitrate, calcium chloride dehydrates, and magnesium chloride hexahydrate were used as purchased. Nitric acid (67%) was used as a digester for ion concentration tests. Polyvinylidene fluoride (PVDF) and N-methyl-2-pyrrolidone (NMP) were purchased from Sigma-Aldrich and used to prepare the coating slurries. Ultrapure water (Millipore, U.S.A.) was used to prepare a feeding solution. Activated carbon (YP50F, Sanwa) was used as the baseline material, with a surface area of ˜1694 m² g⁻¹ as measured by N₂ adsorption/desorption on a Micromeritics ASAP 2020. X-ray photoelectron spectroscopy (XPS) spectra of samples were obtained using a PerkinElmer PHI 5440 ESCA spectrometer with monochromatic Mg Kα radiation as the X-ray source. Anion-exchange membrane (AEM, FAS-PET-130) was purchased from FUMATECH BWT GmbH.

Preparation of MPS-GO/AC composite. First, 2 g of graphene oxide (GO) was dispersed in 50 mL concentrated nitric acid and heated for 2 hours while stirring. The acid-treated GO was washed twice with DI water and three times with absolute ethanol, and then dispersed in 200 mL absolute ethanol with the help of sonication, resulting in GO dispersion (10 mg/mL). Then, 6 mg of 3-(Mercaptopropyl)trimethoxysilane (MPS) was added to 30 mL GO dispersion and heated at 60 for 4 hours. The MPS-modified GO (MPS-GO) was washed three times with absolute ethanol, and then mixed with 0.7 g of activated carbon in 50 mL ethanol. The mixture was stirred in a fume hood to obtain a dried MPS-GO/AC composite, which was dried overnight under vacuum at 60° C. and then ground to pass through a 325-mesh sieve.

Characterization of GO, AC, and MPS-GO/AC composite morphology. The morphologies of the as-prepared sample were characterized by scanning electron microscopy (SEM) and energy-dispersive X-ray spectroscopy (EDS), performed on a Hitachi S-4800 SEM machine equipped with a Bruker EDS detector. Powder X-ray diffraction (XRD) was performed on a Bruker D8 DISCOVER diffractometer with Cu Kα radiation. Raman spectroscopy was carried out using a Renishaw 1000B Raman microscope with a 632.8 nm HeNe laser with three accumulations of 10 seconds each. The surface area measurements were carried out by Brunauer, Emmett, and Teller (BET) N₂ adsorption/desorption on a Micromeritics ASAP 2020. The pore size was analyzed based on a quenched solid density functional theory (QSDFT) kernel applied to the adsorption branch using a slit-pore model. Fourier transform infrared (FTIR) spectroscopy was measured on a Nicolet 5700 FT-IR spectrometer in the range of wave numbers 400-4000 cm⁻¹ at a resolution 4 cm⁻¹. X-ray photoelectron spectroscopy (XPS) spectra of samples were obtained using a PerkinElmer PHI 5440 ESCA spectrometer with monochromatic Mg Kα radiation as the X-ray source.

Preparation of electrodes. To prepare the electrodes, the AC or the MPS-GO/AC was mixed with carbon black and polyvinylidene fluoride (PVDF) binder (72:8:20, by weight) in N-methyl-2-pyrrolidone (NMP) to form a homogeneous slurry. The resulting slurry was coated onto a graphite foil using a doctor blade method, dried under vacuum at 80° C. overnight, and cut to 4.2×4.2 square inches to obtain single-side electrodes. The mass loading of activated carbon on the single-side electrode was approximately 2.2 mg cm². To prepare double-side electrodes, the carbon slurry was coated on the backside of the single-side electrode before cutting.

Analysis of performance of MPS-GO/AC composite. A single-pass model was used. A CD1 cell demonstrated in our previous report (Dong et al., Chem. Eng. J. 2019, 361, 1535-1542) was used to test the CDI performance of the MPS-GO/AC composite. The cell allows a radial flux through the CDI cell from bottom center to four corners of the anodes and finally out of the cell from top center. Feeding water was pumped to the CDI cell from a reservoir by a peristaltic pump at a flow rate of 23 mL min⁻¹, which was a measured value when the flow rate was set to be 25 mL min⁻¹ by the pump. Typically, a two-layer-electrode cell was composed of a double-sided anode sandwiched by two single-sided cathodes. In the cases of cells with more electrode layers, double-sided cathodes were added, together with more double-sided anodes. For example, an 8-layer-electrode cell was assembled with two layers of single-sided cathodes, three layers of double-sided cathodes, and four layers of double-sided anodes. The cathodes consisted of MPG-GO/AC composite, while the anode was composed of the AC. Anion-exchange membranes (AEM) were applied to improve the removal efficiency and discharge efficiency. Silicone gaskets were used on each electrode layer to seal CDI cells. Cation exchange membranes (CEMs) were not used because lead ions can be trapped in the CEMs (Dong et al., Chem. Eng. J. 2019, 361, 1535-1542). A voltage of −1.2 V and 1.2 V was applied to the CDI cell during charging and discharge processes, respectively, controlled by a CHI 670E electrochemical workstation. Note that to remove cations, the charge voltages for the working electrodes were set to be negative by the electrochemical potentiostat.

The ion concentration of the effluent water was measured by inductively-coupled plasma-optical emission spectroscopy (ICP-OES) according to the US EPA standard (US EPA Method 6010D—Inductively Coupled Plasma-Optical Emission Spectrometry 2014, 1-35). The removal efficiency and removal rate of each cation were calculated according to Equations 1 and 2, respectively:

$$\begin{matrix}e = \frac{{c}_{0} - c}{{c}_{0}} \times 100 \% & ( 1 ) \\ E \% = \frac{{\int }_{0}^{t} e dt}{t} & ( 2 )\end{matrix}$$

where c represents the concentration at the given sampling time, c₀ is the initial concentration, and t is the charging duration.

The discharge rate was calculated by comparing the discharged cations with the corresponding accumulated adsorbed cations based on Equation 3:

$$De \% = \frac{( {c}_{i} - {c}_{0} ) v}{{ec}_{0} t} \times 100 \% \qquad ( 3 )$$

where v is the volume of discharge effluent, and cᵢ is the concentration of discharged cation.

Selective removal of Pb²⁺ was indicated by the relative removal coefficient calculated based on Equation 4,

$$S = \frac{{e}_{Pb}}{{e}_{B}} \times \frac{{c}_{B}}{{c}_{Pb}} \qquad ( 4 )$$

where e_{Pb} and e_{B} indicate the removal efficiency of Pb²⁺ and the other species (e.g., Ca²⁺ and Mg²⁺), and c_{Pb} and c_{B} are their concentrations, respectively.

### Example 2

### Surface Modification of IPS on the GO Surface

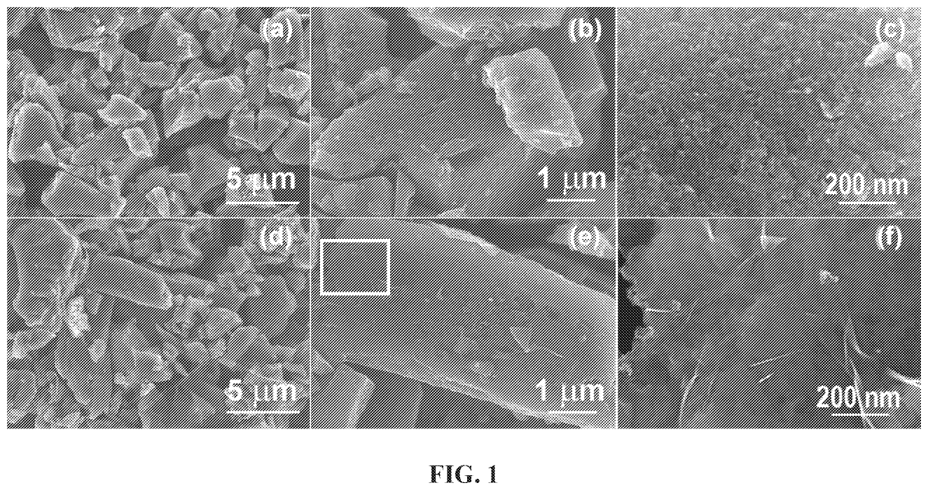

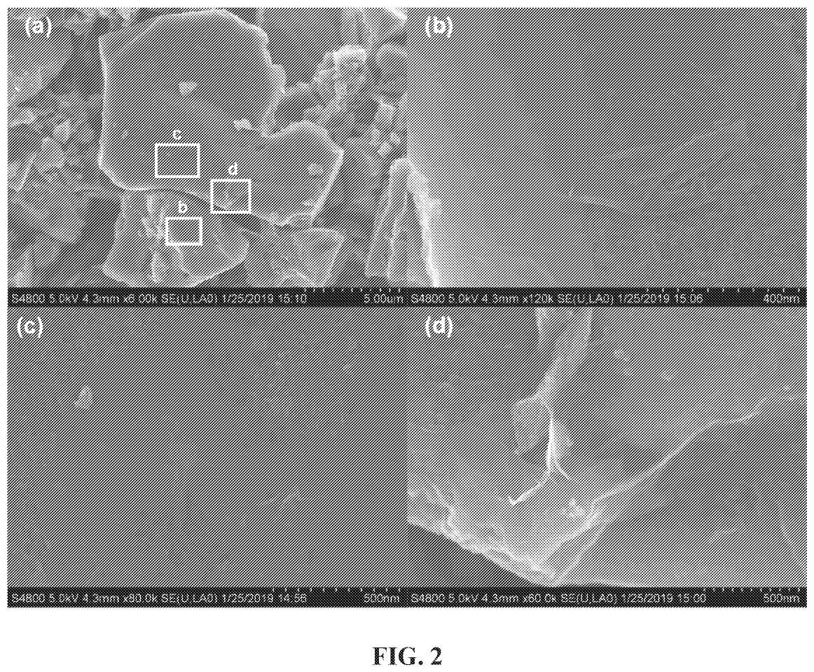

The AC consists of micro-sized particles (typically 1-6 μm) with a porous surface (less than 10 nm), as shown in FIG. 1A-1C. The GO was functionalized by thiol groups using 3-(Mercaptopropyl)trimethoxysilane (MPS). The MPS possesses silane groups that have been widely used to functionalize GO through the condensation reaction (Lee et al., PCCP 2015, 17, 9369-9374; Li et al., J Mater Sci 2015, 50, 5402-5410; Lonkar et al., Nano Res 2015, 8, 1039-1074; Abbas et al., Nanoscale 2018, 10, 16231-16242) while the thiol groups in the MPS can selectively capture lead ions due to the strong affinity between lead ions and thiol groups. Compared with the AC, the MPS-GO/AC depicts similar morphology in low magnification images; however, MPG-GO sheets were observed covering the surface of the AC (FIG. 1D-1F). Additional scanning electron microscopy (SEM) images of the MPG-GO/AC composite, shown in FIG. 2, suggest incomplete coverage of the MPS-GO, but most of the AC was coated with the MPS-GO sheets.

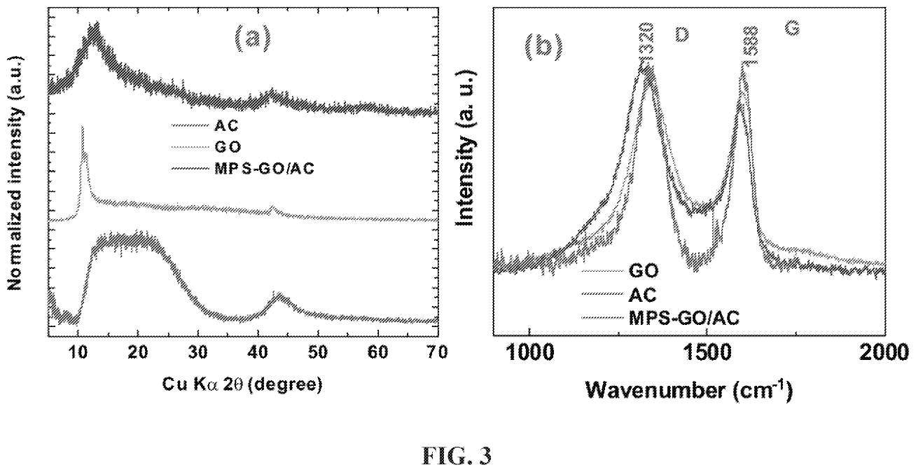

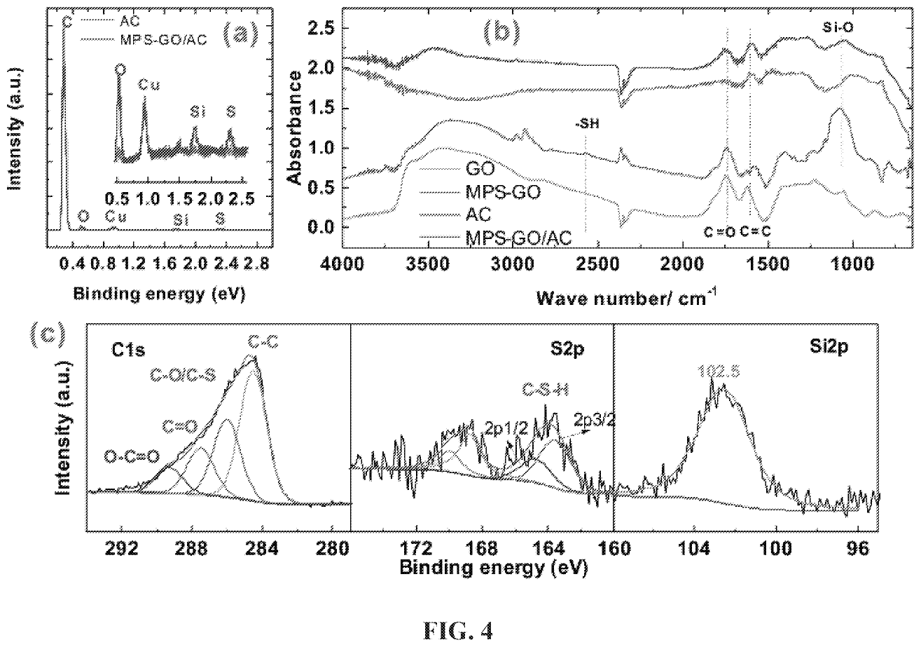

The AC and the MPG-GO/AC were first examined by X-ray diffraction (XRD) and Raman spectroscopy (FIG. 3). The AC showed a very broad peak at 10-30° in the XRD pattern (FIG. 3A), which was indexed to the 002 facet of graphitic carbon and was affected by the micropores in the AC (Huang et al., ACS Sustain Chem Eng 6 2018, 16308-16314). The GO exhibited a sharp peak at 11°. By combining the effects of the AC and GO, the MPS-GO/AC composite showed the major peak at 12.6°. Raman spectra of both the AC and the GO present a D-band and G-band at 1,320 cm⁻¹ and 1,588 cm⁻¹, respectively (FIG. 3B); however, compared with the AC, GO showed a much larger amount of defect carbon. As a result, the MPS-GO/AC composite exhibited a higher ID/IG ratio than the AC (1.3 vs. 1.0). However, X-ray diffraction (XRD) and Raman spectroscopy did not show any information about the functional groups (FIG. 3). Thus, energy dispersive X-ray spectroscopy (EDS) analysis was used to identify functional groups in the carbon materials. The C and O contents in the AC were 98.1 and 1.9 wt. %, respectively, suggesting relatively low O-containing groups (FIG. 4A). In contrast, the C and O contents were determined to be 82.5 and 15.8 wt. %, respectively, confirming the increased O content in the MPS-GO/AC. In addition, Si and S were detected, with contents of 0.82 and 0.89 wt. %, respectively, due to the surface modification of the thiol groups from the MPS.

The evidence of the surface modification was also examined by Fourier-transform infrared spectra (FTIR). As shown in FIG. 4B, the MPS-GO/AC composite presented a relatively strong C═O absorbance at 1,738 cm⁻¹ compared with that of the AC; however, no obvious absorbance from —SH was observed, owing to the typical weak response of the —SH (Zhang et al., Plos One 2015, 10; Zahabi et al., J. Water health 2016, 14, 630-639; Xia et al., Appl. Surf Sci. 2017, 416, 565-573; Viltuznik et al., J. Sol-Gel Sci. Technol. 2013, 68, 365-373; Arakaki et al., Thermochim. Acta 2006, 450, 12-15) and the low GO content (30 wt. %) in the MPS-GO/AC composite. Therefore, the FTIR of the GO and the MPS-GO were compared to find evidence of functionalized thiol groups. Two major peaks at 1,738 and 1,610 cm⁻¹ in the FTIR of the GO were assigned to C═O and C═C (Xie et al., Electrochim. Acta 2018, 290, 666-675; Chen et al., Journal of Cleaner Production 2018, 174, 927-932), respectively; in contrast, a weak peak at 2,570 cm¹ in the MPS-GO resulted from the thiol group (—SH) (Zhang et al., Plos One 2015, 10; Xia et al., Appl. Surf. Sci. 2017, 416, 565-573). In addition, the peak at 1,068 cm⁻¹ was ascribed to Si—O (Tian et al., Langmuir 2010, 26, 4563-4566), indicating successful surface modification of the MPS on the GO surface. The successful surface graft of MPS was further confirmed by X-ray photoelectron spectroscopy (XPS). As shown in FIG. 4C, the S 2p for C—S—H and the Si 2p for Si—O were observed at 164 and 102.5 eV, respectively. Note that the peak for S 2p at approximately 169 eV is uncertain at this stage, but was reported to be originated from oxidized sulphur (—SOxH) (Chen et al., RSC Adv. 2014, 4, 46527-46535).

### Example 3

### MPS-GO/AC CDI Efficiently and Selectively Removes Lead from Water

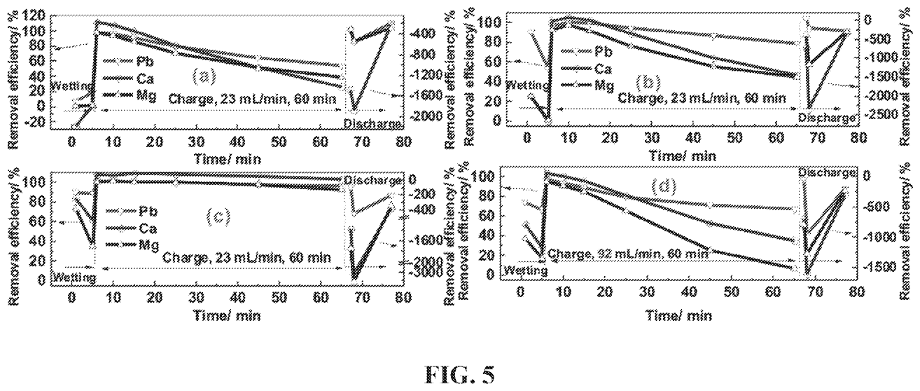

The CDI performance was tested using a lamellar cell, in which multiple electrodes were stacked while the solution was pumped in from the bottom centre, spread to the four corners of the cell, and then finally flew out of the top centre. All the tests were conducted using the single-pass mode, because it is closer to the practical application compared with the batch mode (El-Deen et al., ACS Appl. Mater. Interfaces 2016, 8, 25313-25325; Laxman et al., Desalination 2015, 359, 64-70; Laxman et al., Electrochim. Acta 2015, 166, 329-337). The AC demonstrated selective Pb removal against Ca²⁺ and Mg²⁺; however, the selectivity needs improvement (Dong et al., Chem. Eng. J. 2019, 361, 1535-1542). Prior to demonstrating the CDI performance of the MPS-GO/AC composite in tap water, it was necessary to investigate its performance in synthetic water, namely pure water with Pb²⁺, Ca²⁺, and Mg²⁺. As shown in FIG. 5, applying four layers of AC electrodes achieved an average lead removal rate of 74.2% with a discharge rate of 47% (FIG. 5A). In contrast, applying four layers of MPS-GO/AC composite electrodes enabled the CDI cell to achieve an average lead removal rate of ˜99% with a discharge rate of 34% (FIG. 5C), which was even better than its performance with eight layers of AC electrodes (average Pb removal of 90%; FIG. 5B). Note that the negative removal efficiencies during discharge indicate the ions were released from the electrodes because the removal efficiency is defined by the concentration difference between the influent and the effluent, divided by the influent concentration (Equation 1). The related concentrations at the third point during discharge processes are the average concentrations of all the discharge water minus that was taken for the first two discharge samples; the discharge rate was thus calculated based on the ratio of the total amount of each discharged ion to the total volume of collected solution (Equation 3).

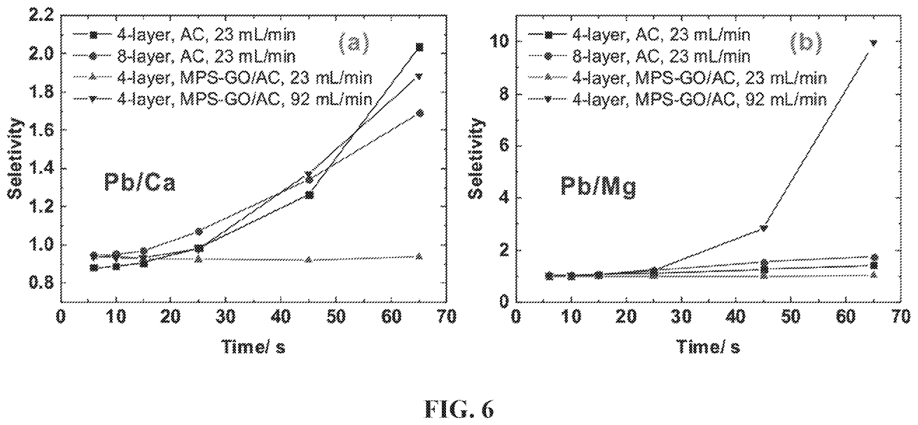

The relatively lower discharge in the presence of the MPS-GO/AC is due to the strong affinity between the thiol and lead ions. Extended discharge time could provide a higher lead release. Due to the nearly complete removal of all ions using the four-layer-electrode CDI cell with the MPS-GO/AC at 23 mL min⁻¹, no removal selectivity of Pb²⁺ against Ca²⁺ and Mg²⁺ can be observed (FIG. 6). Therefore, a higher flow rate (92 mL min⁻¹) was introduced to the cell, resulting in significant removal selectivity of Pb²⁺ against Ca²⁺ and Mg²⁺, plus an average lead removal rate of 78% with a discharge rate of 45% (FIG. 5D). In other words, compared with the AC, the four-layer-electrode cell with the MPS-GO/AC showed a higher lead removal rate and improved Pb removal selectivity against Ca²⁺ and Mg²⁺ at quadruple the flow rate. This indicates the benefit of the surface-modified GO. As can be seen, selective removal of Pb²⁺ against Ca²⁺ and Mg²⁺ was observed since ˜20 min. As a matter of fact, the selectivity values were even smaller than 1, e.g., as shown in FIG. 3A, which is due to the greater mobility of Ca²⁺ than Pb²⁺. Note that the selectivity of Pb²⁺/Mg²⁺ was much higher than that of Pb²⁺˜/Ca²⁺ and the selective removal of Pb²⁺ against Ca²⁺ and Mg²⁺ occurred at later charging stage (FIG. 6), which is related to the replacement mechanism of selective removal of Pb²⁺ against Ca²⁺ and Mg²⁺. Ca²⁺ and Mg²⁺ possess a higher mobility than Pb²⁺ and can be electrosorbed on the electrode more quickly than Pb²⁺ at an early stage; however, the Ca²⁺ and the Mg²⁺ that arrived earlier at the electrode are replaced by the Pb²⁺ because it has a stronger affinity with the functional groups (such as thiol and carboxyl) than Ca²⁺ and Mg²⁺. Meanwhile, Mg²⁺ exhibited a water exchange rate five orders of magnitude slower than that for Ca²⁺ because of the stable inner hydration shell of Mg²⁺. As a result, Pb²⁺ replaces more Mg²⁺ than Ca², resulting in a higher Pb removal selectivity against Mg²⁺ than Ca²⁺.

### Example 4

### Phosphate Ions in Tap Water Prevent Discharge of Lead Ions

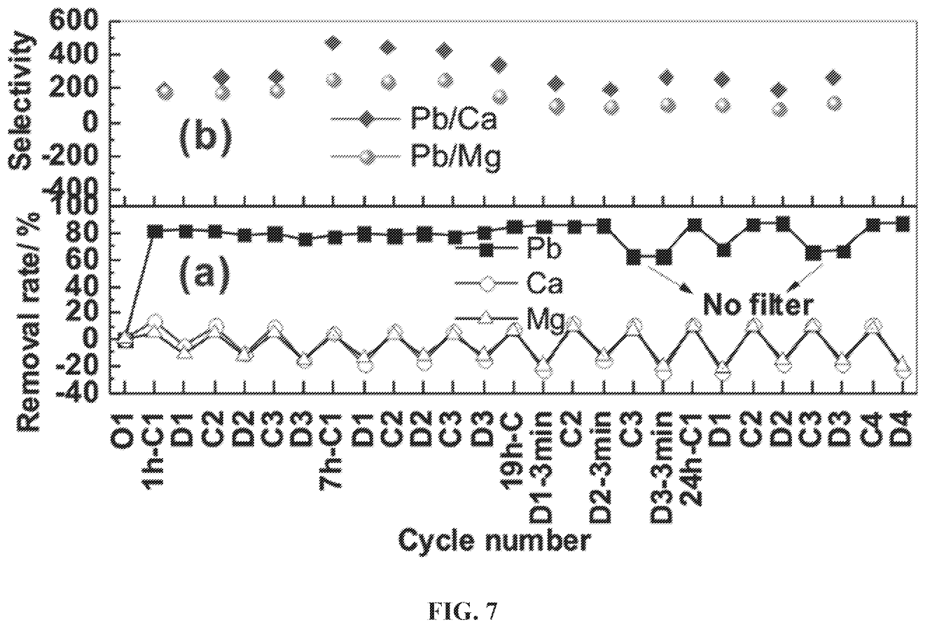

The CDI performance of the MPS-GO/AC was further tested using tap water with regeneration processes, which is an approach toward practical applications. The water quality of the used tap water can be found in reports by Milwaukee Water Works (Milwaukee Water Works: 2018 Distribution System Water Quality, 2019). The lead-contaminated tap water was simulated by adding 1 ppm of Pb² into tap water from a University of Wisconsin-Milwaukee (UWM) office building, in which the Ca²⁺ and Mg²⁺ concentrations are typically 33 and 11 ppm, respectively. As shown in FIG. 7, the Pb removal rates were higher than 80%; in contrast, the removal rates for Ca²⁺ and Mg²⁺ were 5-15% and 3-10%, respectively. Therefore, the average Pb removal selectivity against Ca and Mg was as high as 292 and 158, respectively (FIG. 7B), much higher than the numbers (1-7) using pristine AC in our previous report (Dong et al., Chem. Eng. J. 2019, 361, 1535-1542). Note that increased removal rates were observed after running for 7 h, which is due to the decreased adsorbed Ca²⁺ and Mg²⁺. For example, the removal rates at the first hour (C1) were approximately 15% and 5% for Ca and Mg and were approximately 5% and 3% at the 7th hour (7 h-C1), respectively.

Surprisingly, however, no discharge of the adsorbed Pb²⁺ was observed during the discharge processes. As shown in FIG. 7A, upon discharge the removal rates for Ca²⁺ and Mg²⁺ were negative, which means these cations did not discharge from the electrodes; in contrast, the Pb removal rates were still above 80%, instead of below zero, which indicates the Pb was removed rather than released. Meanwhile, extending the discharge time to 3 min did not make a difference (FIG. 7A).

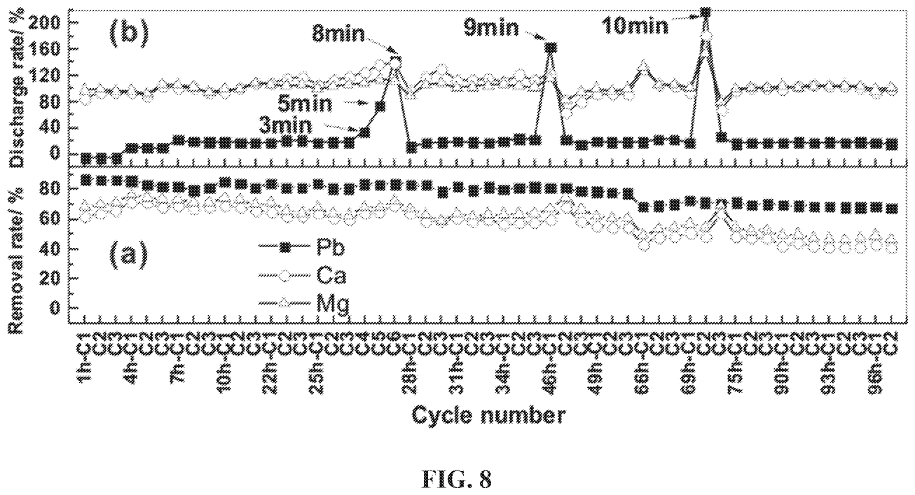

To determine the cause of the inability of the CDI cell to release Pb²⁺, tap water from the UWM office building was simulated by generating synthetic water containing 1 ppm Pb²⁺, 30 ppm Ca²⁺, and 10 ppm Mg²⁺. As shown in FIG. 8, the four-layer-electrode CDI cell ran uninterrupted for 96 h by pumping the synthetic water. The CDI cell was charged for 8 min to remove ions, followed by a typical 2-min discharge to release the adsorbed ions. The initial Pb removal rate was approximately 85%, retained higher than 80% over 300 cycles and above 70% over 500 cycles. Low discharge rates of lead were observed (typically ˜20%) unlike tap water where Pb was unable to be discharged (FIG. 7A). In contrast, the discharge rates for Ca²⁺ and Mg²⁺ were above 90%. The relatively low Pb discharge rate is related to the stronger bonding of thiol groups and Pb²⁺ ions, which resulted in an incomplete recovery for Pb²⁺ in 2 min. Pb discharge rates were observed by extending the discharge time to 3-5 min (FIG. 8B); extending the discharge time to 8-10 min raised the Pb discharge rate above 100%, indicating the accumulated lead ion can be discharged. In other words, a deep discharge can help regenerate electrodes after a period of typical use cycles with a short discharge time; therefore, a long discharge time for each cycle is not necessary.

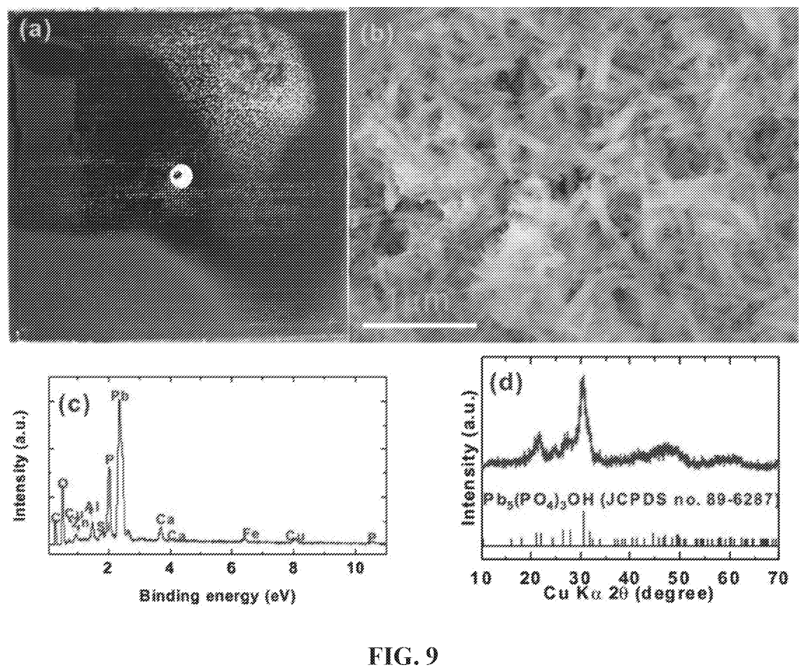

By comparing the regeneration performance with tap water and synthetic water, it was clear that the inability to discharge Pb²⁺ with tap water was related to a component in the tap water itself. To uncover the reason, the CDI cell was taken apart after running 24 h with the Pb-contaminated tap water; white precipitate was found in the mesh separator between the electrodes (FIG. 9A). The white precipitate was examined by SEM, which showed needle-like morphology up to 1 μm in length (FIG. 9B). The precipitate primarily consisted of Pb, P, and O, with minor components of Ca, Al, Fe, Cu, and Zn, as indicated by EDS analysis (FIG. 9C). XRD characterization suggests the precipitate primarily consisted of Pb₅(PO₄)₃(OH) (FIG. 9D). Therefore, Pb was not released during discharge because the Pb₅(PO₄)₃(OH) precipitate formed as a result of native phosphate ions in the tap water, which was absent in the synthetic water.

### Example 5

### Characterization Lead Phosphate Formation

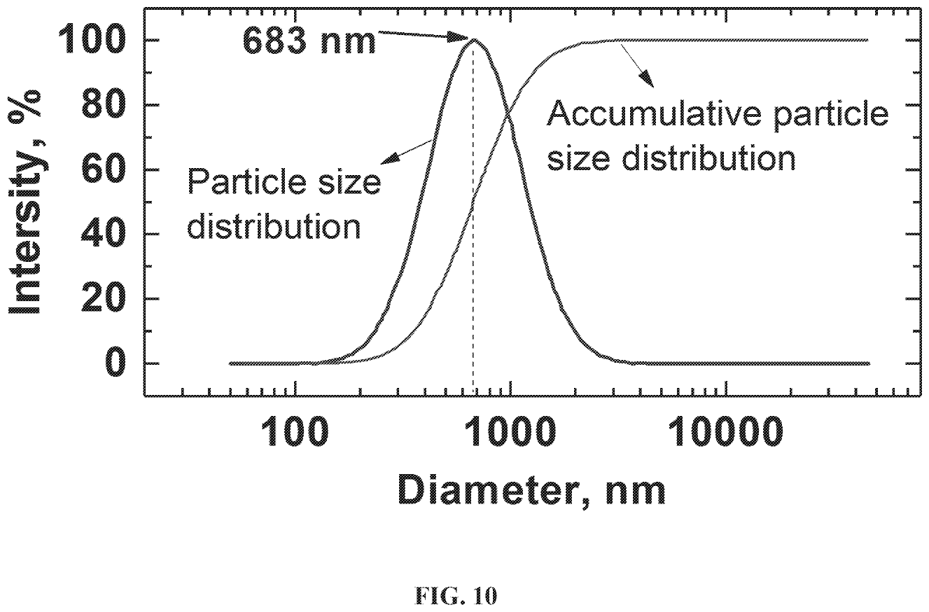

The mechanism for the formation of lead phosphates was investigated. Phosphate ions are popular in drinking water, which, according to WHO, helps to control the pH value (approximately 8) and resist corrosion. Thereby, suppressing the lead leaching from old lead-containing water pipes. TABLE 1 exhibits the typical orthophosphate ion concentrations, ranging between 0.08-1.87 ppm, in 10 top-population counties in Wisconsin in 2017; the values for Chicago and New York in 2017 were 1.12 and 2.10 ppm, respectively. The solubility product contents of Pb₃(PO₄)₂ were as low as 8.0×10⁻⁴³, which easily leads to the formation of lead phosphate particulates in tap water, even when lead concentrations are very low. For example, with a Pb concentration of 1 ppm, phosphate ions are required at only 8.0×10⁻³⁷ g L⁻¹ to start forming particulates, which is much higher than the typical phosphate ion concentration in tap water (TABLE 1). A fresh tap water sample with 1 ppm lead was examined with a laser particle size analyzer, presenting a mean particle size of 683 nm (FIG. 10); such small particles in tap water stay suspended without forming precipitates. As an evidence, during the CDI test process no significant Pb concentration change was observed in the feeding tank containing 24 L tap water with 1 ppm Pb.

TABLE 1
Water quality of major cities (counties) in 2017.

| | Lead (Pb) | | | Calcium (Ca) | | | Orthophosphate (PO₄³⁻) | | |
|---|---|---|---|---|---|---|---|---|---|
| CITY | Max* | Min. | Ave. | Max. | Mm. | Ave. | Max. | Mm. | Ave. |
| (COUNTY) | (μg/L) | (μg/L) | (μg/L) | (mg/L) | (mg/L) | (mg/L) | (mg/L) | (mg/L) | (mg/L) |
| Milwaukee | 130 | 4 | 0.00 | 36.00 | 35.00 | 35.50 | 2.97 | 0.77 | 1.87 |
| Madison | 118 | 0 | 2.29 | 110.00 | 45.30 | 67.15 | 0.29 | 0.15 | 0.22 |
| (Dane) | | | | | | | | | |
| Kenosha | 95.7 | 0 | 2.49 | 85.00 | 0.57 | 32.99 | 0.09 | 0.08 | 0.08 |
| Green Bay | 66 | 0 | 3.95 | 91.00 | 12.00 | 42.21 | 0.26 | 0.16 | 0.22 |
| (Brown) | | | | | | | | | |
| Racine | 147 | 0 | 4.14 | 97.20 | 0.38 | 37.59 | 1.00 | 0.17 | 0.75 |
| Appleton | 71 | 0 | 1.99 | 270.00 | 6.68 | 50.29 | 0.26 | 0.19 | 0.24 |
| (Outagamie) | | | | | | | | | |
| Waukesha | 140 | 0 | 2.58 | 130.00 | 11.10 | 82.19 | 0.52 | 0.11 | 0.36 |
| Eau Claire | 39 | 0 | 1.97 | 62.10 | 0.05 | 15.56 | N/A | N/A | N/A |
| Oshkosh | 25 | 0 | 3.91 | 120.00 | 0.08 | 34.16 | 0.64 | 0.54 | 0.58 |
| Janesville | 470 | 0 | 4.63 | 93.00 | 0.29 | 64.49 | N/A | N/A | N/A |
| Chicago | <1 | <1 | <1 | 36.40 | 35.90 | 36.09 | 1.39 | <0.06 | 1.12 |
| New York | 3 | 0 | 0.00 | 30.20 | 5.10 | 7.30 | 3.00 | 0.70 | 2.10 |

Data of 10 Wisconsin counties were taken from dnr.wi.
*Maximum lead in Wisconsin was from first-draw samples at taps in 50 homes with lead services.

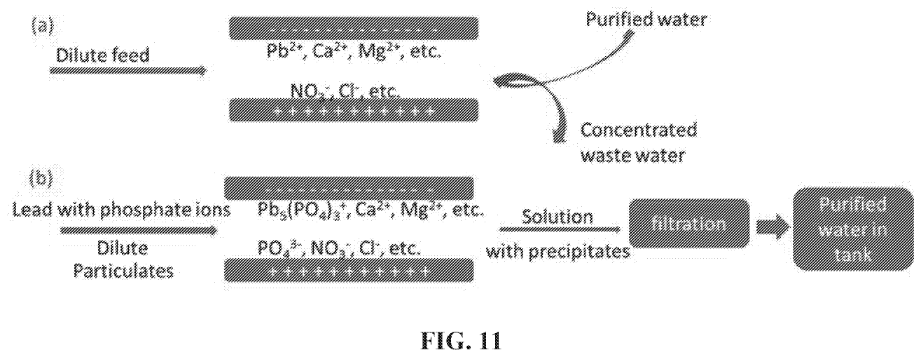

To help understand the effect of phosphate ions on CDI performance, an illustration scheme is presented in FIG. 11. Without phosphates ions, cations and anions are adsorbed onto cathodes and anodes during charging and the concentrated ions are released as free ions upon discharging. In contrast, in the presence of phosphate ions, Pb contaminates are primarily suspended in tap water as particulates. The lead in tap water exists in the form of particulates (Pb₃(PO₄)₂) after addition of phosphates because of the very low solubility product constant of lead (8.0×10⁻⁴³), which leads to easier removal of lead during charging. The Pb particulates can be adsorbed onto the cathode during charging because they are negatively charged. Upon discharging, the accumulated phosphate ions are released from the anode, together with the lead particulates discharged from the cathode, which results in formation of precipitates (FIG. 11B). The resulting micro-sized precipitates can be removed with a filter.

Interestingly, with the assistance of the phosphate ions, no wastewater needs to be disposed. Upon charging, the Pb is removed by electrochemically adsorbing onto the electrode; during discharging, the Pb is removed in the form of precipitates that can be filtrated, resulting in a new zero-wastewater CDI technique. In contrast, the water recovery with the conventional CDI technique is approximately 75%, because concentrated ions must be discharged as wastewater.

In summary, an MPS-GO/AC composite was prepared for selective lead ion removal against Ca²⁺ and Mg²⁺. While very high Pb removal selectivity was observed during the single-pass CDI processes, no free Pb²⁺ was released in the case of tap water; instead, lead phosphate precipitates were collected due to the presence of phosphate ions. Because of the extremely low-solubility product content of lead phosphate, Pb exists in tap water in a form of particulate, which can be electrochemically attracted to cathodes upon charging. The accumulated Pb particulates are released and form precipitates with the concentrated phosphates ions from anodes, which can be removed with an additional filter, resulting in no wastewater. A summary of previous reports related to removal of Pb²⁺ using CDI techniques are shown in TABLE 2, demonstrating the novel findings of the present disclosure.

TABLE 2
Summary of the previous reports related to removal of lead ions by CDI.

| | | | | PO₄³⁻ | Wastewater | |
|---|---|---|---|---|---|---|
| Materials | Mode | Water type | Investigated cations | related | generation | Ref. |
| Activated | Batch | DI | Cd²⁺, Pb²⁺, and Cr³⁺ | No | Yes | Huang et al., J. |
| carbon cloth | | | | | | Hazard. Mater. 2016, |
| | | | | | | 302, 323-331 |
| Fe3O4/porous | Batch | crystal | Pb²⁺, Cu²⁺, and Cd²⁺ | No | Yes | Bharath et al., Sep. |
| graphene | | violet | | | | Purif. Technol. 2017, |
| | | dye | | | | 188, 206-218 |
| | | solution | | | | |
| O-Doped | Batch | DI | Zn²⁺, Cd²⁺, Pb²⁺, | No | Yes | Chen et al., J. Mater. |
| boron nitride | | | Ni²⁺, Co²⁺, Cu²⁺, | | | Chem. A 2017, 5, |
| nanosheets | | | Mg²⁺, Ca²⁺, Fe²⁺, | | | 17029-17039 |
| | | | Fe³⁺ and Na⁺ | | | |
| EDTA or | Batch | DI | Pb²⁺ and Na⁺ | No | Yes | Liu et al., J. Mater. |
| APTES- | | | | | | Chem. A 2017, 5, |
| grafted | | | | | | 14748-14757 |
| graphene | | | | | | |
| porous N- | Batch | DI | Pb²⁺, Cd²⁺, Cu²⁺, | No | Yes | Liu et al., Chem. |
| doped | | | Ni²⁺, Zn²⁺, Co²⁺, | | | Commun. 2017, 53, |
| graphene | | | Fe²⁺, Mg²⁺, and Ca²⁺ | | | 881-884 |
| Activated | Single- | DI | Pb²⁺, Mg²⁺, and Ca²⁺ | No | Yes | Dong et al., Chem. |
| carbon (AC) | pass | | | | | Eng. J. 2019, 361, |
| | | | | | | 1535-1542 |
| AC/MPS-GO | Single- | Tap water | Pb²⁺, Mg²⁺, and Ca²⁺ | Yes | No | Present disclosure |
| | pass | | | | | |

Note:
DI represents de-ionized water

Besides lead, other heavy-metal ions (such as Cu, Cd, and Ni) also can be selectively removed against Ca and Mg ions, because their solubility product contents of Cu₃(PO₄)₂ (1.40×10⁻³⁷), Cd₃(PO₄)₂ (2.53×10⁻³³), and Ni₃(PO₄)₂ (4.74×10⁻³²) are at least two orders of magnitude smaller than those of Ca₃(PO₄)₂ (2.07×10⁻²⁹) and Mg₃(PO₄)₂ (1.04×10⁻²⁴). Therefore, with the help of native phosphate ions in tap water, multiple heavy metals (e.g., lead, copper, cadmium, nickel) can be selectively removed against calcium and magnesium ions in such a zero-wastewater CDI. This shows promising applications in water treatment, especially in drinking water systems.

While several embodiments of the present invention have been described and illustrated herein, it is to be understood that the foregoing embodiments are presented by way of example only and that, within the scope of the appended claims and equivalents thereto, the invention may be practiced otherwise than as specifically described and claimed.

What is claimed is:

1. A composite material comprising:
activated carbon; and
thiol-functionalized graphene oxide coated on the activated carbon.

2. The composite material of claim 1, wherein the activated carbon is in the form of particles.

3. The composite material of claim 2, wherein the particles are micro-sized particles from 0.5 to 50 μm in diameter.

4. The composite material of any of claims 1-3, wherein the activated carbon comprises pores less than 50 nm.

5. The composite material of any of claims 1-4, wherein the thiol-functionalized graphene oxide is graphene oxide functionalized with a thiol-containing group, the thiol-containing group comprising a —C₁₋₁₀alkylene-SH group.

6. The composite material of claim 5, wherein the thiol-containing group is -silyl-C₁₋₁₀alkylene-SH.

7. The composite material of claim 6, wherein the -silyl-C₁₋₁₀alkylene-SH group is -silyl-(CH₂)₃—SH.

8. The composite material of any of claims 1-7 having from 0.1 to 5 weight % sulfur.

9. The composite material of any of claims 1-8 further comprising carbon black.

10. The composite material of any of claims 1-9 further comprising a binder.

11. An electrode comprising the composite material of any of claims 1-10.

12. The electrode of claim 11, further comprising a current collector, the composite material being coated on the current collector.

13. The electrode of claim 12, wherein the current collector is a conductive carbon material or titanium.

14. The electrode of claim 13, wherein conductive carbon material is a graphite body, carbon paper, or carbon cloth.

15. A capacitive deionization cell comprising a first electrode and a second electrode, the first electrode being the electrode of any of claims 11-14.

16. The capacitive deionization cell of claim 15 further comprising an anion exchange membrane.

17. The capacitive deionization cell of claim 15 or 16, wherein the cell is a lamellar or cylindrical cell.

18. The capacitive deionization cell of claim 15 or 16, wherein the cell is configured as a flow-by mode cell or a flow-through cell.

19. A water purification system comprising
one or more capacitive deionization cells of any of claims 15-18;
an electrical circuit for controlling the operation of the one or more capacitive deionization cells; and
a filter, the filter being in fluid communication with the one or more capacitive deionization cells.

20. The system of claim 19, wherein the filter is configured to entrap a phosphate salt selected from the group consisting of lead, copper, cadmium, nickel, and mercury.

21. The system of claim 20, wherein the phosphate salt is a lead phosphate salt.

22. The system of claim 21, wherein the lead phosphate salt comprises Pb₅(PO₄)₃(OH).

23. A method of removing a heavy metal ion from a water supply comprising:
(a) applying a voltage to one or more capacitive deionization cells of any of claims 15-18;
(b) directing the water supply through the one or more capacitive deionization cells; and
(c) adsorbing the heavy metal ion at the first electrode;
wherein the heavy metal ion is a lead, copper, cadmium, nickel, or mercury ion.

24. The method of claim 23, further comprising
(d) reversing the voltage;
(e) releasing the heavy metal ion from the first electrode into the water supply;
(f) directing the heavy metal ion-containing water out of the one or more capacitive deionization cells; and
(g) collecting a phosphate salt of the heavy metal ion by filtration.

25. The method of claim 23 or 24, wherein the heavy metal ion is Pb^{2+.}
